(19) United States
(12) Patent Application Publication
(10) Pub. No.: US 2026/0291245 A1
(43) Pub. Date: Sep. 24, 2026

(54) V2X UTILIZING A METER

(71) Applicant: Landis+Gyr Technology, Inc., Alpharetta, GA (US)

(72) Inventors: Matt KARLGAARD, Pequot Lakes, MN (US); Adrian SHARMAN, Alpharetta, GA (US); Shishir SHEKHAR, Alpharetta, GA (US); David DECKER, Alpharetta, GA (US); Nicholas P. MERRICKS, Alpharetta, GA (US); Charlotte SAND, Alpharetta, GA (US); Lukasz DUDEK, Alpharetta, GA (US); Amith KOTA, Alpharetta, GA (US)

(21) Appl. No.: 19/474,324

(22) PCT Filed: Apr. 15, 2024
(86) PCT No.: PCT/US2024/024597

§ 371 Date: Oct. 10, 2025

Related U.S. Application Data
(60) Provisional application No. 63/495,798, filed on Apr. 13, 2023.

(51) Int. Cl. H02J 3/32; B60L 53/62; B60L 53/63; B60L 53/64; B60L 53/66; B60L 55/00; H02J 13/12; H02J 13/34

(52) U.S. Cl. CPC H02J 3/322; B60L 53/62; B60L 53/63; B60L 53/64; B60L 53/66; B60L 55/00; H02J 13/12; H02J 13/34; B60L 2260/58

(57) ABSTRACT

Systems and methods for controlling vehicle-to-everything (V2X) functionality of an electric vehicle charger via a multi-port meter. The meter may comprise a grid port configured for connecting the meter to an electric power grid, an auxiliary port configured for connecting the meter to the electric vehicle charger, a grid switch connected to the grid port and configured for connecting the grid port to the load port and an auxiliary switch configured for connecting the auxiliary port to the grid switch and the load port. The system may further comprise a bi-directional communication channel configured for communications between the system and the electric vehicle charger or an electric vehicle connected to the electric vehicle charger, and a control unit. The control unit comprises one or more processors configured for processing power grid data measured by the meter and controlling states of the grid switch and the auxiliary switch to thereby facilitate various V2X functionality.

### TECHNICAL FIELD OF THE DISCLOSURE

The present disclosure relates to electricity meters for charging electric vehicles, and in particular but not exclusively to the management of Vehicle-to-Everything enabled processes by a meter.

### BACKGROUND OF THE DISCLOSURE

The present disclosure generally provides a system for coordinating the charging of an electric vehicle, and in particular for Vehicle-to-Everything coordination.

Electric Vehicles (EVs) form a growing segment of the automobile market, accounting for 5.8% of all new cars sold in the United States in 2022. EV's share of the global new car market is expected to continue its growth in coming years, with many countries such as the United Kingdom committing themselves to banning the sale of new petrol and diesel cars within the next decade. It is therefore anticipated that there will be an increased need for charging EVs as EV ownership continues to increase.

An emerging technology in the EV market vehicle-to-everything (V2X). V2X is the overarching term for transferring the electricity stored in the batteries of an EV for other uses, such as to the grid (V2G), to houses (V2H) or other buildings (V2B), and/or any other energy-consuming destination. Existing V2X systems and processes are typically controlled by the vehicle or EV charger themselves, and as a result every vehicle or charger is provided with its own, often proprietary, standards and control systems. As well as increasing costs for the consumer, this vehicle or charger side control results in the charging of the EVs being largely invisible to utility companies, who are therefore less able to anticipate and account for the benefits of V2X systems in electricity storage and production. This limits the ability of customers and utility companies to utilise EVs as part of a distributed energy resource (DER) network.

### SUMMARY OF THE DISCLOSURE

In general, aspects of the present disclosure may provide a system comprising an electricity meter for charging a V2X compatible EV, and in particular a system configured to coordinate the V2X capabilities of the EV.

The system may therefore manage the charging and discharging of an electric vehicle to serve some or all of the following purposes:
to minimize energy costs and/or the carbon footprint of the end user (e.g. by coordinating best charging times that will enable the user to use the car as needed and will charge at the lowest rate, discharging when it is beneficial to do so);
as part of a utility system, to use stored energy in an EV battery and the managing of charging times of EVs to help to reduce the need to increase the transmission and distribution capacity of the power network; and
to provide resilience for the end user by providing power during an outage

In general, these purposes may be facilitated through the meter by:
1. Coordinating charging times to enable users to charge a battery of an EV at the lowest rates while still charging the EV for intended use.
2. Discharging the battery of the EV during high rate periods if it is advantageous to do so, and then charging the battery of the EV during low rate periods.
3. Coordinating the connection and disconnection of the meter from the grid (e.g. by opening a grid switch), and instructing the EV charger to export energy utilizing V2X functionality such as a vehicle-to-home (V2H) output.

Additional optimisation inputs may also be considered by the system, including but not limited to:
total electricity price, including various tariffs & taxes;
peak load tariff;
V2X efficiency, including charging/discharging losses;
financial benefits from participation in flexibility programs;
local energy production sources (for example, whether the electricity is from green sources such as solar or wind); and
battery life implications (e.g. of multiple charge/discharge cycles).

The system may comprise an optimisation algorithm configured to account for one or more of these factors. For example, the algorithm may normalise any tariffs or other expected costs (such as increased battery replacement rates) to a common unit, such as $ per kWh, and determine whether or not to operate the V2X functionality based on costs savings for the end user or utility company. The algorithm can either run in the meter (or a control unit of the meter) itself or in an aggregation/orchestration platform.

As such, based on the output of the algorithm, the electric vehicle charger may be controlled to enter into or remain in one of 3 general states:
1. A charge mode for charging the battery of the EV, optionally wherein the charging rate is less than 100% of a potential or available charging rate.
2. A rest or standby mode for maintaining a current charge level in the battery of the EV.
3. A discharge mode for exporting energy from the battery of the EV utilizing V2X.

Various combinations and conditional requirements for entering these states may be orchestrated by the electricity meter.

Thus, according to a first aspect of the invention there is provided a system for controlling a vehicle-to-everything (V2X) compatible electric vehicle charger, the system comprising:
a multi-port meter comprising:
   a grid port configured for connecting the meter to an electric power grid;
   an auxiliary port configured for connecting the meter to an electric vehicle charger;
   a load port configured for connecting the meter to a premises load;
   a grid switch connected to the grid port and configured for connecting the grid port to the load port;
a bi-directional communication channel configured for communications between the system and the electric vehicle charger or an electric vehicle connected to the electric vehicle charger;
   and
a control unit, the control unit comprising one or more processors configured for processing power grid data measured by the meter and controlling states of the grid switch;
wherein the system is configured to:
   open the grid switch to electrically disconnect the grid port and the load port;
   transmit a signal to the electric vehicle charger to turn on its V2X output to an output mode; and
   provide the output of the electric vehicle charge to the premises load via the auxiliary port and the load port.

The meter may be an American National Standards Institute (ANSI) compatible multi-port meter, for example an ANSI Form 43S multi-port meter.

The control unit may be an external unit configured to control the switches of the meter, or may otherwise consist of e.g. processors and memory systems integrated with the meter itself. Where the control unit is an external unit, the control unit may comprise one or more communication channels for communicating with the meter. Similarly, the communication channel may be a communication channel between the electric vehicle/electric vehicle charger and the (external) control unit or the meter itself. For example, the control unit may be a processing unit or other computing device of the electric vehicle or the electric vehicle charger.

The bi-directional communication channel between the system and the EV or V2X-capable EV charger may be a direct wireless connection utilizing any of WiFi, radio frequency (RF), ultrahigh frequency including Bluetooth, cellular, satellite, ZigBee, WiMax, WiSun, and/or other wireless communication technologies. Alternatively, the bi-directional communication channel may be a wired connection using Ethernet or other wired communication technologies. Further alternatively, the communication channel may be facilitated by an intermediary. For example, the EV charger system may connect to a cloud system via one of the above listed communication types, and the meter or control unit may also connect to that same intermediary (e.g. cloud system) via the same or different communication type.

Further communication channels may also be provided, for example between the system and the power grid or the utility provided.

The meter may be configured to open the grid switch in response to a variety of conditions, based on instructions from the control unit. For example, the grid switch may be opened in response to the system detecting a loss of power from the electric power grid. Alternatively, the system may be configured to open the grid switch in response to an indication that electricity unit prices from the electric power grid have exceeded a threshold value. Further alternatively, the system may be configured to open the grid switch in response to an indication that usage of the electric power grid has exceeded a threshold proportion of its total capacity.

The system may detect one or more of these conditions based on power grid data measured by the meter. Additionally or alternatively, the system may comprise a second communication channel for facilitating communications with the power grid, and may receive an indication from the power grid via this communication channel to open/close the grid switch.

Optionally, the system may be configured to transmit a second signal to the electric vehicle charger to turn off its V2X output. Following this, the system may close the grid switch.

The transmission of the second signal may be e.g. in response to the condition that resulted in the original opening of the grid switch no longer being fulfilled. For example, if the grid switch is opened in response to a power outage of the power grid, the second signal may be transmitted when grid power is restored.

The system may be configured to receive a confirmation signal from the electric vehicle or the electric vehicle charger indicating that the V2X output has been turned off. The meter may additionally be configured to close the grid switch in response to the receipt of the confirmation signal by the meter. Advantageously, the receipt of the confirmation signal may reduce the risk of both the electric power grid and the electric vehicle charger supplying power to the premises load simultaneously, and therefore reduce the risk of the load port or other meter port being overloaded.

According to a second aspect of the invention there is provided a system for controlling a vehicle-to-everything (V2X) compatible electric vehicle charger, the system comprising:
a multi-port meter comprising:
   a grid port configured for connecting the meter to an electric power grid;
   an auxiliary port configured for connecting the meter to the electric vehicle charger;
   a load port configured for connecting the meter to a premises load;
   a grid switch connected to the grid port and configured for connecting the grid port to the load port;
   an auxiliary switch configured for connecting the auxiliary port to the grid switch and the load port;
a bi-directional communication channel configured for communications between the system and the electric vehicle charger or an electric vehicle connected to the electric vehicle charger; and
a control unit, the control unit comprising one or more processors configured for processing power grid data measured by the meter and controlling states of the grid switch and the auxiliary switch;
wherein the system is configured to:
   responsive to a first condition, determine that the electric vehicle charger should cease charging a battery of an electric vehicle;
   transmit a signal to the electric vehicle charger to cease charging the battery of the electric vehicle;
   responsive to a second condition, determine that the electric vehicle charger should resume charging the battery of the electric vehicle; and
   transmit a second signal to the electric vehicle charger to resume charging the battery of the electric vehicle.

The meter may be an American National Standards Institute (ANSI) compatible multi-port meter, for example an ANSI Form 43S multi-port meter.

At the same time as or shortly after transmitting the signal to cease charging the battery of the electric vehicle, the system may open the auxiliary switch to electrically disconnect the electric vehicle charger from the grid port. In implementations, the system may open the auxiliary switch without transmitting a signal to the electric vehicle charger.

In implementations, the first condition is a price of energy from the electric power grid being above a threshold price, and the second condition is the price of energy from the electric power grid being below a second threshold price. The first threshold price and the second threshold price may be equal, or they may be different. Advantageously, this facilitates the charging of the electric vehicle using cheaper electricity, reducing costs to the end consumer.

Optionally, the system may be configured to implement V2G functionality by discharging the battery of the electric vehicle to the electric power grid. For example, the system may be configured to:
responsive to a third condition, determine that the electric vehicle charger should output energy to the electric power grid;
transmit a third signal to the electric vehicle charger to turn on its V2X output to an output mode; and
provide the output of the electric vehicle charger to the electric power grid via the auxiliary port and the grid port.

In an implementation, the first condition is a price of energy from the electric power grid being above a threshold price, and wherein the second condition is the price of energy from the electric power grid being below a second threshold price, and the third condition is the price of energy from the electric power grid being above a third threshold price. Advantageously, this may allow the end user to store energy during cheaper periods and re-sell that energy to the utility company during peak usage times.

The first, second and third threshold prices may all be equal, or one or more of the prices may be different. For example, the third threshold price may be greater than the first threshold price. Advantageously, by suitable selecting the relative threshold prices the system or user may account for losses inherent to the battery charging/discharging process, ensuring that the battery is only discharged when it would be profitable for the end user.

In a further implementation, the third condition may be the receipt of an indication or instruction from a utility provider to discharge energy to the grid. For example, the utility company may request that an EV be discharged during peak usage periods. Similarly, the first and second conditions may respectively comprise an indication from the utility provider to cease charging the EV, and an indication from the utility provider to cease discharging the EV to the grid. It will be understood that the first and third conditions may be provided in a single instruction or indication from the utility provider.

Optionally, the system may be provided with a set of user comfort settings. Such comfort setting may include, but are not limited to:
threshold battery charges;
permitted battery charging/discharging times;
required battery charging/discharging times;
intended use times for the EV;
a highest acceptable energy unit price for charging the EV battery;
a lowest acceptable energy unit price for discharging the EV battery to the utility grid (i.e. for implementing V2G functionality);
a desired energy type for charging the EV battery (e.g. renewable energy sources);
maximum power levels to be transferred into/out of a battery in a given time period (e.g. based on a kWh into or out of the EV battery);
a maximum number of times to discharge the EV battery per unit time or otherwise a maximum number of charging cycles per unit time;
a maximum kW to discharge; and
a maximum kWh to discharge per unit time.

It will be understood that different settings may be used based on the desired usage of the V2X functionality. For example, the system may comprise a different set of comfort settings for outage-based islanding vs. intentional islanding vs. fully-connected grid-supporting V2X discharge. Similarly, the same comfort settings may be provided with different parameters for each case.

Based on the user comfort settings, the system may be configured to determine one or more additional conditions for switching the electric vehicle charger between charge, discharge and standby modes. For example, the user may provide a comfort setting a minimum battery charge level (e.g. 50%), and the first or third conditions may comprise determining that the current charge level of the battery of the electric vehicle is greater than the threshold charge level (e.g. that the battery's current charge level is greater than 50%).

The system may receive regular updates from the electric vehicle or electric vehicle charger to assist in meeting these conditions. For example, when the electric vehicle charger is set to the discharge mode, it may provide an updated indications of the current battery charge level to the system. The updates may be provided e.g. every set period of time (e.g. every few minutes or any other suitable time period) or based on a change in the battery charge percentage (e.g. a new update each time the battery charge level changes by 1%). Based on these updates, the system may control the electric vehicle charger to switch between the charge, standby and discharge modes as the various conditions swap being true and false.

In another example, the user comfort settings comprise an intended use time for the electric vehicle. In this case, a charging conditions may comprise only ceasing charging of the battery of the electric vehicle if it is not within a threshold time period of the intended use time. Alternatively, the use comfort settings may be combined into a single charging conditions. For example, the charging conditions may comprise only ceasing charging of the battery of the electric vehicle within the threshold time period of the intended use time if the battery charge level is above a desired charge level.

According to a third aspect of the disclosure, there is provided a method of controlling a vehicle-to-everything (V2X) compatible electric vehicle charger, method comprising:
operatively connecting a multi-port meter to an electric power grid via a grid port of a multi-port meter;
operatively connecting the multi-port meter to an electric vehicle charger via an auxiliary port of the multi-port meter;
operatively connecting the multi-port meter to premises load via a load port of the multi-port meter;
opening a grid switch to electrically disconnect the grid port and the load port;
transmitting a signal to the electric vehicle charger to turn on its V2X output to an output mode; and
providing the output of the electric vehicle charge to the premises load via the auxiliary port and the load port.

According to a fourth aspect of the disclosure, there is provided a method of controlling a vehicle-to-everything (V2X) compatible electric vehicle charger, method comprising:
operatively connecting a multi-port meter to an electric vehicle charger via an auxiliary port of the multi-port meter;
responsive to a first condition, determine that the electric vehicle charger should cease charging a battery of an electric vehicle;
transmit a signal to the electric vehicle charger to cease charging the battery of the electric vehicle;
responsive to a second condition, determine that the electric vehicle charger should resume charging the battery of the electric vehicle; and
transmit a second signal to the electric vehicle charger to resume charging the battery of the electric vehicle.

As discussed above, the present disclosure encompasses systems comprising a meter and one or more external control units, as well as meters with integrated control functionality. For example, a system may comprise a multi-port meter and a control unit comprising a non-transitory storage medium and one or more processors. The storage medium may contain a set of computer readable instructions that, when read by the processor, cause the processor to control the meter to carry out the desired method steps.

These above examples are not intended to limit or define the limits of the present subject matter, but to provide an example to aid understanding thereof. Illustrative examples are discussed in the Detailed Description below, and further description is provided there. Advantages offered by various examples may be further understood by examining this specification and/or by practicing one or more examples of the claimed subject matter.

### BRIEF DESCRIPTION OF THE EMBODIMENTS

Some embodiments of the disclosure will now be described by way of example only and with reference to the accompanying drawings, in which:

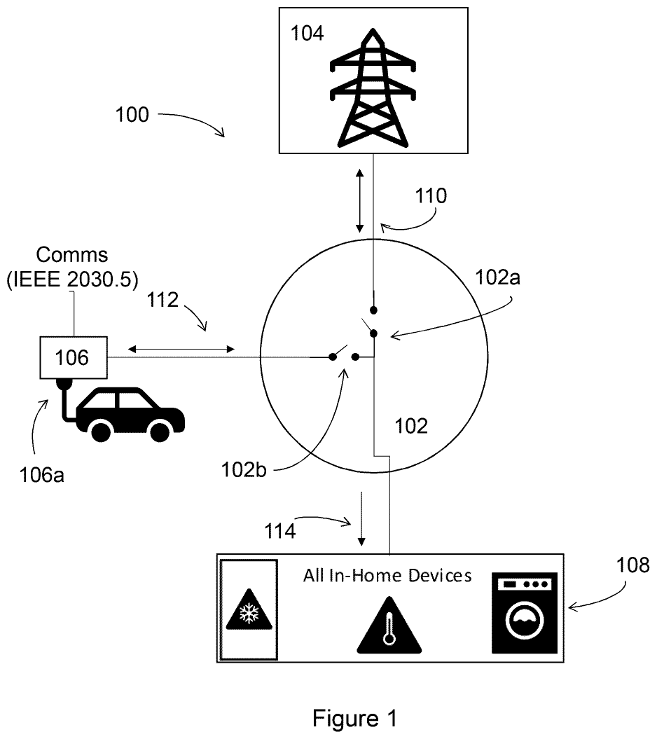

FIG. 1 depicts a schematic diagram of an example system according to the present disclosure.

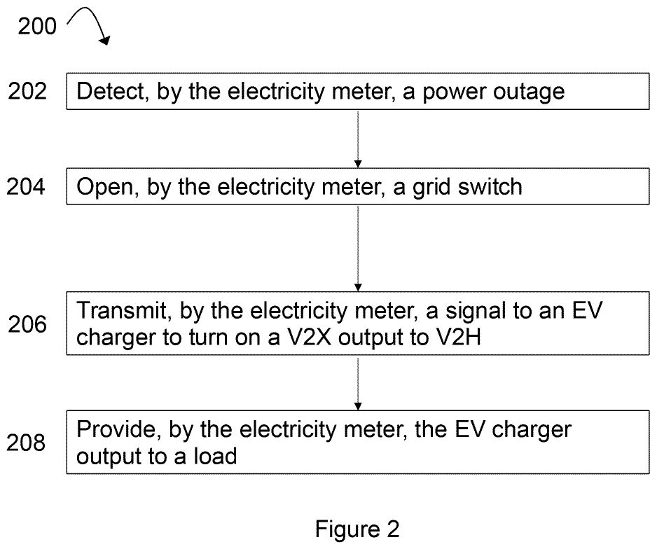

FIG. 2 depicts a flow diagram of an example method according to the present disclosure.

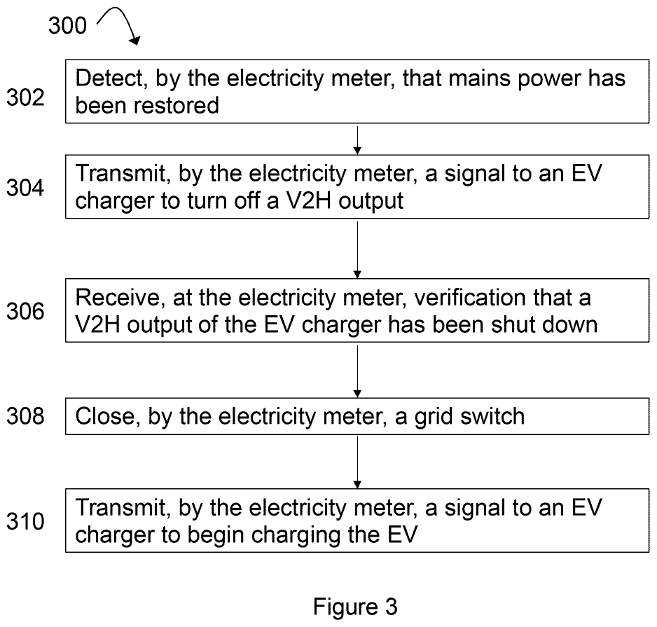

FIG. 3 depicts a flow diagram of a further example method according to the present disclosure.

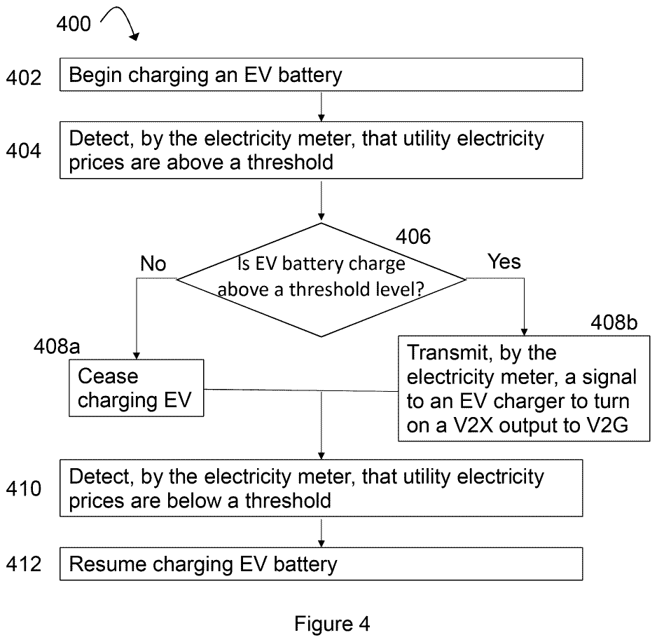

FIG. 4 depicts a flow diagram of a further example method according to the present disclosure.

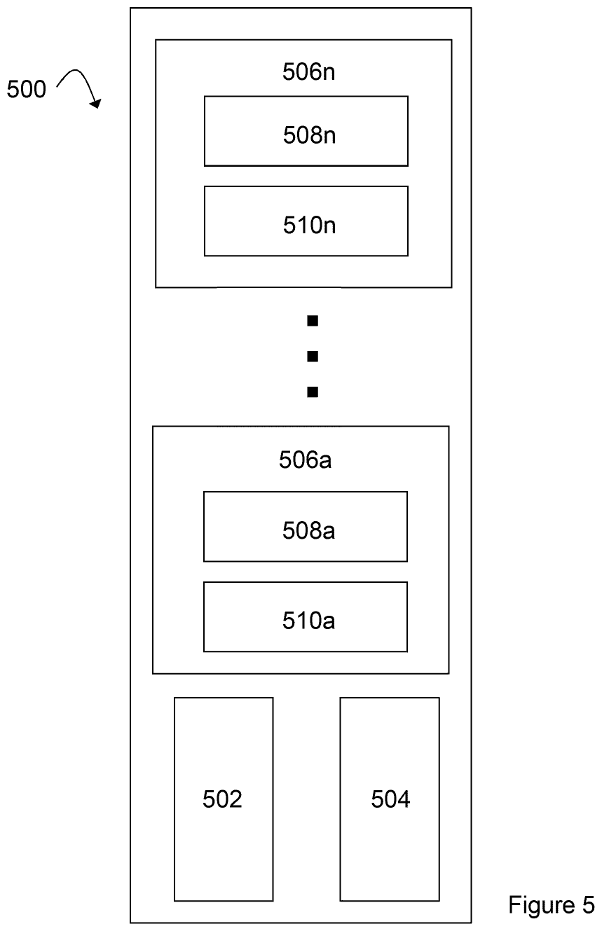

FIG. 5 depicts a schematic block diagram of an example electricity meter according to the present disclosure.

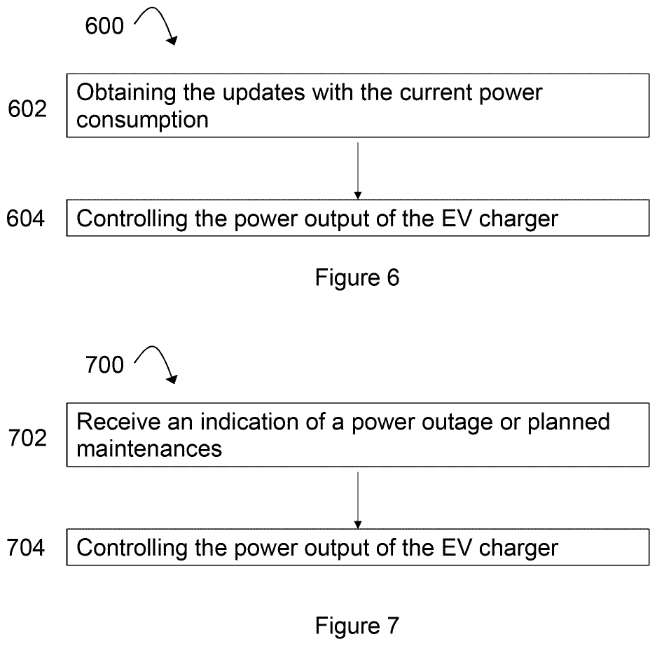

FIG. 6 depicts a flow diagram of a further example method according to the present disclosure.

FIG. 7 depicts a flow diagram of a further example method according to the present disclosure.

### DETAILED DESCRIPTION OF THE EMBODIMENTS

Aspects of the invention will now be described by reference to example embodiments. It will be understood that the implementations depicted and described herein are provided as illustrative examples, and are not intended to limit the scope of the present invention to only the depicted embodiments.

FIG. 1 depicts a schematic diagram of a system 100 according to an embodiment of the disclosure. The system comprises a multi-port electricity meter 102 with first, second and third ports 110, 112 and 114. First port 110 is configured as a grid port for connecting to the utility grid 104 or other electricity supply, such as a building specific generator. Third port 114 is configured as a load port for supplying electricity to a load 108, such as a home or other building or premises. The meter may be an ANSI Form 43S multi-port meter, or any other suitable meter.

Second port 112 is an auxiliary port configured as a distributed energy resources (DER) port. The DERs may comprise, but are not limited to, solar panels, small natural gas-fueled generators, electric vehicles (EVs), wind generating units (at residential or commercial premises), battery storage systems, smart appliances, and controllable loads such as HVAC systems and electric water heaters. In system 100, auxiliary or DER port 112 is operatively connected to a V2X enabled EV charger 106. The charger may have V2X capabilities facilitated by the use of any suitable connection 106a to an EV, for example a CHAdeMO or CCS standard connection, or incoming communication standards such as ISO15118. The EV charger 106 may comprise a communication module configured for facilitating communication between the charger 106 and the meter 102. The communications module may be configured to use any suitable communications technologies and protocols for communications with the meter 102, such as IEEE 2030.5 protocols.

The system may further comprise one or more communication channels. For example, the meter 102 comprises a bi-directional communication channel for communicating with the utility grid 104, a second bi-directional communication channel for communicating with the EV charger 106, and a third uni-directional communication channel for communicating with the premises load 108. It will be understood that, where an external control unit is provided, these communication channels may instead be between the control unit and the respective loads. The (external) control unit may additionally comprise a communication channel for facilitating communications between the control unit and the meter. More generally, the system or meter itself may comprise one or more communication channels for each potential load, and these communication channels may be or may be configured as uni or bi-directional communication channels.

The communication channels may be controlled by a communications module (not shown) of meter 102 or the control unit. The communication module may be configured for any suitable communications means, including wireless, wired, or power line communication. Example wireless communication technologies may include but are not limited to WiFi, radio frequency (RF), ultrahigh frequency including Bluetooth, cellular, satellite, ZigBee, WiMax, and/or other wireless communication technologies. Example wired communication means may include

Ethernet or other wired communication technologies. Example power line communication means may include technologies following the P2030.5 standard or other alternative standards for power line communications. The communications module may also use one or more of the following communication protocols: Modbus, CIP, EtherCAT, DNP, IEEE 2030.5, or other communication protocols. Other protocols and communication technologies will be apparent to the skilled person.

The communication channels between could be a direct wireless or wired channel using one of the methods listed above, or any other methods apparent to the skilled person. Alternatively, the channels may be facilitated by an intermediary. For example, such as the V2X system (i.e. EV or EV charger) may connect to a cloud system first through one of those communication types (such as WiFi), while the meter and/or control unit also connects to that cloud system (e.g. via mesh or WiSun or cellular), to thereby facilitate communications between the EV charger and the meter system via a cloud server.

While the below disclosures will refer to a meter comprising an integrated control unit for controlling the meter functionality, it will be understood that the discussions of the advantages and functionality of system 100 is equally applicable to a corresponding system comprising a meter such as meter 102 and an external control unit connected to the meter.

System 100 may be configured to provide coordination of the V2X at the meter 102 itself. In comparison to V2X systems that are coordinated at external devices (for example, by a processor or other computing device of an EV), the coordination at the meter 102 may improve the visibility of V2X operations to a utility provider, and therefore facilitate improved coordination between the utility company and DER devices such as EVs. For example, V2X systems may include, but are not limited to, the following functionality:
Vehicle to Grid (V2G) functionality, such as returning or ‘selling’ energy from an EV battery to the grid 104 to enable the energy consumer to take advantage of higher rates, for example during peak usage hours;
Vehicle to Home (V2H) functionality, such as discharging an EV battery to supplement a building's 108 energy needs during high rate periods and/or disconnecting the building 108 from the grid 104 (islanding) during a power outage to thereby utilize the EV battery to power the building 108; and
Coordination of best charging times based on predicted or real-time photovoltaic (PV) production or other low energy rates.

Advantageously, a determination to transition to these operating modes and/or to enter the premises into an islanding mode may be made at the meter. The determination to transition the operation mode of the EV charger at the meter has the benefit of allowing the meter to adapt the operations of the EV charger in response to or anticipation of a variety of conditions, including changes in the grid output, planned change in the grid output (e.g. due to engineering works), or any other conditions that affect the availability of power.

As a result, by utilising, for example, local intelligence built into the meter 102 and/or the intelligence of an overarching coordinating system that may have visibility and control over multiple devices connected to meter 102, the meter 102 may manage the charging and discharging of an EV to serve some or all of the following purposes:
to minimize energy costs for the end user and/or reduce carbon emissions, for example, by coordinating best charging times that will enable the user to use the EV as needed and will charge at the lowest rate, discharging when it is beneficial to do so;
as part of a utility system, for example via the use of stored energy in an EV battery and the managing of charging times of EVs to help to reduce the need to increase the transmission and distribution capacity of the power network; and
to provide resilience for the end user by providing power during an outage.

To assist in these processes, the meter 102 may comprise first and second switches 102a,b connected to the first and second ports 110, 112. In the illustrated example, first switch 102a is connected to the first or grid port 110, and may therefore be referred to as a grid switch. Similarly, as second switch 102b is connected to the second or auxiliary/DER port 112, it may be referred to as an auxiliary or DER switch. Switches may be configured to control the flow of electricity to/from the meter 102 via the first and second ports 110, 112, as will be further discussed below. It will be appreciated that the meter 102 may be powered by a suitable power supply (e.g. 240V) from e.g. the grid or DER port, and/or a combination of the two based on which of the grid and DER switches are open or closed at a given time. Alternatively, a dedicated power supply may be provided for the meter, such as a battery. Advantageously, the provision of a battery power supply for meter 102 may allow the meter to continue operating for a period of time when external power supplies are lost, such as during a blackout event for utility grid 104.

It will be understood that, while system 100 is depicted with a three port multi-port meter 102, the system may instead comprise any other suitable meter, including a traditional 2-port meter or any N-port meter, including N-port meters with 4, 5, 6 or more ports. A traditional meter may be configured with a V2X-capable EV charger as one device on the load side, while a suitable N-port meter may be configured with a DER port connected to a V2X-capable EV charger. In all cases, the system may comprise a bi-directional communication channel to the EV charger or electrical vehicle.

Each DER device 106a,b may be operably connected to an inverter (not shown). An inverter can regulate the power generated by the DER device 106a,b so that the phase, amplitude, and frequency of the power generated complies with the required electrical ratings of devices within the micro-grid or the power grid 104. The inverter may provide a synchronous output, such that its output voltage amplitude, frequency, and phase track the voltage amplitude, frequency, and phase of the grid 104. When the inverter instead provides an isochronous output, it may determine its output voltage amplitude, frequency, and phase without tracking the grid 104.

As discussed, to implement the V2X functionality the electric vehicle charger may be controlled to enter into or remain in one of 3 general states:
1. A charge mode for charging the battery of the EV, optionally wherein the charging rate is less than 100% of a potential or available charging rate.
2 A rest or standby mode for maintaining a current charge level in the battery of the EV.
3. A discharge mode for exporting energy from the battery of the EV utilizing V2X.

Various additional states may also be implemented based on an output of the optimisation algorithm. These states may be used for EV smart charging and flexibility services, to integrate the user's preferences, and needs of the car and the grid. For example, the states may include:

| States Group Name | Explanation | States Group Components |
|---|---|---|
| PLUGGED_IN_CHARGER_STATES | All plugged in chargers | StateManualPlugged |
| | | StateNoRulesActive |
| | | StateSmartPaused |
| | | StateSmartCharging |
| | | StateSafeCharging |
| | | StatePreconCharging |
| | | StateChargingOverdue |
| | | StateChargeCompletedFull |
| | | StateChargeCompletedUserMax |
| | | StateChargeCompletedDailyDistance |
| | | StateLocalBattery |
| PLUGGED_IN_AND_LOCAL_BATTERY_{—} | Plugged in chargers that can | StateSmartCharging |
| CONTROLLABLE_CHARGER_STATES | participate in flexibility | StateSmartPaused |
| | | StateChargeCompletedDailyDistance |
| | | StateLocalBattery |
| UNPLUGGED_CHARGER_STATES | All unplugged chargers | StateUnplugged |
| | | StateManualUnplugged |
| UNPLUGGED_CHARGE_RULE_READY_STATES | Chargers unplugged by system | StateUnplugged |
| CHARGING_CHARGER_STATES | Charging chargers | StateSmartCharging |
| | | StateSafeCharging |
| | | StatePreconCharging |
| | | StateChargingOverdue |
| CHARGING_AND_CONTROLLABLE_CHARGER_STATES | Charging chargers that can | StateSmartCharging |
| | participate in flexibility | StatePreconCharging |
| UNPLUGGED_AND_LOCAL_BATTERY_{—} | Chargers unplugged by system | StateUnplugged |
| CONTROLLABLE_CHARGER_STATES | that can participate in flexibility | |
| LOCAL_BATTERY_STATES | Plugged in chargers that are | StateLocalBattery |
| | participating in | |
| | flexibility | |
| ALL_CHARGER_STATES | All chargers | StateALL |

FIGS. 2-4 show various example methods that may be implemented by meter 102. Each method may correspond to a particular implementation of V2X functionality that is controlled and orchestrated by meter 102. The functionality may be implemented by a controller integrated with meter 102 or an external controller connected to or in communication with meter 102. In each case, the controller may comprise a memory device storing a computer program, computer code or other computer implemented instructions, and one or more processors configured to read and process the computer implemented instructions.

FIG. 2 is a flow diagram showing a method 200 for orchestrating V2H functionality by an electricity meter according to the present disclosure. Method 200 generally relates to the implementation of V2H functionality in response to a detected power loss, for example as a result of a blackout or other power outage. In an initial step 202, an electricity meter such as meter 102 may detect a power outage. For example, the electricity meter may detect a loss of input received from a utility grid via a grid port. In implementations in which the electricity meter is powered from the utility power supply, the electricity meter may comprise a holdup power supply or other power storage means to provide temporary auxiliary power to the meter after the loss of the mains supply.

In response to this detection, the electricity meter may, in a step 204, open a grid switch to isolate the electricity switch from the utility grid. The opening of the grid switch may result in an “islanding” of the electricity meter and its associated loads. Examples of suitable islanding operations are described in published US patent application no. 2022/0261026 A1, which is incorporated herein in its entirety.

In step 206, the electricity meter may transmit a signal to an EV charger connected to the meter via a DER port. The signal may comprise instructions for the EV charger to turn on (or otherwise switch) its V2X output to a V2H output. In a V2H mode, the EV charger may discharge a battery of a connected EV, to provide the V2H output to a connected load. In summary however, inverters associated with a DER device may be configured to support islanding by providing a synchronous output and an isochronous output.

In step 208, the V2H output of the EV charger is provided by the electricity meter to a connected load, such as a home or other building.

As a result, method 200 facilitates the ‘islanding’ of the meter and a connected load, to provide power to the load from a charge stored on a battery of an EV connected to the electricity meter via a DER port and a bi-directional communication channel. It will be understood that the islanding functionality of method 200 may also be applied in response to other conditions. For example, step 202 may instead detect that the unit cost of electricity has exceeded a threshold value, or otherwise receive an indication that the utility grid usage has exceeded a threshold fraction of its capacity.

FIG. 3 is a flow diagram showing a second method 300 for orchestrating V2H functionality by an electricity meter according to the present disclosure. Method 300 generally relates to the restoration of normal EV charger functionality. For example, the steps of method 300 may occur after those of method 200, when the relevant condition of step 202 is no longer met. In step 302, the electricity meter may detect or otherwise receive an indication that utility power capabilities have been restored. In other implementations, the electricity meter may instead detect that the unit cost of electricity has fallen below a threshold value, or otherwise receive an indication that the utility grid usage has fallen below a threshold fraction of its capacity.

More generally, it will be understood that the steps of method 300 do not need to be preceded by method 200, and may instead be implemented in any situation in which the EV charger is currently providing V2H or other vehicle-to-load functionality.

In step 304, the electricity meter may transmit a signal to an EV charger connected to the meter via a DER port. The signal may comprise instructions for the EV charger to turn off its V2H output. Optionally, in step 306, the electricity meter may receive confirmation from the EV charger that the V2H output has been shut down. In step 308, the electricity meter may close the grid switch, restoring input from the utility grid via the grid port. Finally, in an optional step 310, the electricity meter may transmit a signal to the EV charger to begin or resume charging an EV vehicle.

FIG. 4 is a flow diagram showing a further method 400 for orchestrating EV battery charging functionality by an electricity meter according to the present disclosure. The electric meter may be configured to transmit control messages to the EV charger to set the EV charger into one of three modes, a charge mode for charging a battery of an EV, a discharge mode for discharging the battery of the EV, and a standby mode for retaining the current charge level of the battery. In a step 402, an EV charger connected to the meter via a DER port is in a charge mode for charging a battery of an EV.

In step 404, the electricity meter detects or otherwise receives an indication that unit prices for electricity are above a threshold value. The threshold value may be set by e.g. the user or the utility company.

In step 406, the electricity meter receives an indication of the current charge level of the EV battery from the EV charger. Based on the current charge, the electricity meter may transmit a control method to set the EV charger to a discharge mode 408b (if the current charge is above a threshold) or a standby mode 408a (if the current charge is below a threshold). In a discharge mode, V2G functionality may be implemented in order to sell or otherwise provide electricity from the EV battery to the utility grid. It will be understood that step 406 is an optional step, and the user may instead configure the electricity meter to cease charging in direct response to the detection in step 404. Similarly, when in a discharge mode, the electricity meter may receive updates on the charge level of the EV battery at regular intervals, and instruct the EV charger to swap to standby mode if the charge level falls below a threshold value.

In step 410, the electricity meter detects that detects or otherwise receives an indication that unit prices for electricity are below a threshold value. The threshold value may be set by e.g. the user or the utility company, and may be the same or a different threshold value to step 404. Finally, in step 412, the electricity meter instructs the EV charger to resume charging the battery of the EV.

It will be understood that method 400 is an example implementation and is not limited solely to the steps shown. For example, due to losses inherent to discharging and charging a battery, the electricity meter may instruct the EV charger to enter standby mode when the electricity unit price is above the first threshold of step 404, and to only enter discharge mode if the electricity unit price is above a second, higher threshold. Additionally, method 400 may be adapted to systems other than that shown in FIG. 1. For example, the electricity meter may be an N-port meter comprising a second DER port connected to a DER energy source, such as a wind turbine or solar panels. In step 404, the electricity meter may detect a current output level of the DER energy source, and instruct the EV charger to charge or cease charging the EV battery based on this output level.

In the above disclosures, threshold values such as threshold electricity prices, threshold EV battery charges, etc., may be selected by the user or otherwise set by a utility company. Additional ‘comfort’ settings and/or conditions may also be available to a user. For example, a user may select a time period during which the electricity meter cannot implement V2G or V2H functionality (for example, to ensure that the EV battery remains charged prior to a typical commuting time). Alternatively, the user or utility company may desire to charge the EV battery from ‘green’ or renewable energy sources such as wind power, solar power, etc. In such cases, step 404 of method 400 may instead detect that a threshold proportion of utility energy is being produced by such green energy sources, and continue, cease or resume charging the EV battery based on this detection.

Available comfort settings may include, but are not limited to:
threshold battery charges;
permitted battery charging/discharging times;
required battery charging/discharging times;
intended use times for the EV;
a highest acceptable energy unit price for charging the EV battery;
a lowest acceptable energy unit price for discharging the EV battery to the utility grid (i.e. for implementing V2G functionality);
a desired energy type for charging the EV battery (e.g. renewable energy sources);
maximum power levels to be transferred into/out of a battery in a given time period (e.g. based on a kWh into or out of the EV battery);
a maximum number of times to discharge the EV battery per unit time or otherwise a maximum number of charging cycles per unit time;
a maximum kW to discharge; and
a maximum kWh to discharge per unit time.

In all cases, the comfort settings may be time dependent. For example, a user may desire a higher minimum charge to be retained in an EV battery between 7 am and 9 pm (when the EV is more likely to be used) and accept a lower minimum charge being retained in the EV battery between 9 pm and 7 am (when the EV is less likely to be used). Similarly, the user or utility company may desire that the EV battery is charged from primarily renewable energy sources when renewable outputs are high (e.g. during summer with typically higher PV cell outputs) and have no or lower requirements during less productive months (e.g. during winter when PV cell outputs are typically lower).

The comfort settings may be controlled via e.g. a website or an application on a computing device, such as a mobile phone application. Alternatively, the comfort settings may be remotely controlled by a utility company.

Based on the comfort settings, the system may be configured to implement user-centric smart charging operations. For example, users may use the comfort settings to implement charging rules by specifying e.g. a ready-at time (to control when the car is supposed to be charged), a desired maximum battery level (e.g. 100%), the days when the rule is active (e.g. weekdays), a desired safety distance (what is the minimum acceptable driving range for the car at any given time (e.g. to get to a hospital or react to any emergency)), and a preconditioning time (how long before ready-at time should the battery be charged e.g. to have it warm when leaving).

Based on these user settings, the system may determine effective charge rules. For example, the system may implement charge rules such that the EV charger will charge the battery to the desired maximum battery level as close as possible to the ready at time.

Based on the charge rules, a charge plan is calculated, taking into consideration all the aforementioned user settings. In addition to these user settings, the system may further account for optimisation signals (e.g. based on CO2 emission forecasts or electricity prices), information about the car & charger (e.g. battery capacity, current battery level & expected charging power), and other relevant information that may not be readily available to the user.

For example, the charge plan may include a preconditioning time if selected by the user. In such a charge plan, a portion of charging is reserved for the time period just prior to the ready at time. For example, if the preconditioning time is 30 minutes, the charge plan may comprise charging the battery to 80% capacity during cheaper off-peak electricity hours (e.g. overnight), and then charging the battery to 100% only in the 30 minutes prior to the ready-at-time.

When configuring the charge plan, the system may coverts the desired safety distance to a percentage of battery capacity. If the current battery level is lower than the desired safety distance percentage, the charge plan may include immediately charging the EV battery to the safety distance percentage. If the current battery level is greater than the desired safety distance percentage, normal Smart Charging occurs, and the system may wait for optimal times to charge the car in accordance to the charge plan.

FIG. 5 depicts a block schematic diagram of an example electricity meter 500. The meter comprises a plurality of ports 506a-n. The meter may additionally comprise one or more communication channels 508 for each port, and optionally a switch 510. Each communication channel may be a uni-directional channel (capable of single direction communications) or a bi-directional channel (configured to both provide and receive communications), configured to facilitate communications with the load or energy supply connected to the corresponding port. The meter may comprise any number of ports 506, for example 2, 3, 4, 5, 6 or more ports. At least one port is connected or connectable to a V2X compatible EV charger.

Electricity meter 500 additionally comprises a storage medium 502 such as a memory and a processor 504. The storage medium 502 may store a computer program or code that, when read by the processor, causes the electricity meter 500 to implement the steps of methods such as methods 200, 300 or 400. Together, the storage medium 502 and processor 504 may form a controller or other control unit. It will be understood that the controller may be an integrated controller forming a component of electricity meter 500, or may be an external controller connected to or in communication with electricity meter 500. Similarly, the functionality of the controller may be implemented in hardware or software, as desired. Where an external controller is provided, the one or more communication channels 508 may be provided by the control unit, rather than the meter 500, and the meter 500 may instead comprise one or more communication channels for communicating with the control unit.

It will be understood from the above disclosures that orchestration of the functionality of the above system may be provided at the meter itself or by an external control unit. The control unit may itself be a dedicated control unit for controlling the meter functionality, or may otherwise be provided by e.g. processors or processing units of an electric vehicle or electric vehicle charger.

In embodiments, the system may comprise multiple meters and an aggregating system configured to orchestrate the functionality of the multiple meters. Advantageously, the aggregating system may facilitate the implementation of frequency containment reserve (FCR) systems, to assist in stabilising the frequency of the power grid. The aggregating system may be configured to orchestrate the functionality of meters and/or EV chargers based on the requirements of the power grid or other regulations. For example, if an average EV charger can provide an output of approximately 11 KW, and the FCR requirement is e.g. 2 MW, the aggregating system may be configured to control about 181 EV chargers. Similarly, if the FCR requirement is 600 kW, then the aggregating system may be configured to control about 54 EV chargers.

FIG. 6 shows a flow diagram depicting an example FCR method 600 for implementation by an aggregating system. The method comprises, in step 602, obtaining the current power consumption of the meters. Preferably, the aggregating system may obtain (or otherwise receive from the meters) regular updates of the power consumption at the meters. For example, the aggregating system may be configured to obtain the updated information at intervals of 10 seconds or less, such as at 1, 2, 3, 4, 5, 6, 7, 8, 9 or 10 second intervals. It will be understood that step 602 may comprise the meters or the control units of the meters transmitting the consumption information to the aggregating system at these intervals.

In step 604, based on the consumption information, the aggregating system may transmit instructions to one or more of the connected meters. The instructions may comprise instructions to control the power output of the EV charger. The aggregating system may be enabled to fully control the output of the EV charger (e.g. between 0 and 100% of the potential output), or may be restricted to controlling the output of the EV charger between predefined thresholds (such as between 30 and 70% of the total potential output of the EV charger, or between 50 and 100% of the total potential output of the EV charger). The aggregating system may be configured such that the EV chargers react to the instructions in a short period of time, e.g. within 5 seconds, or otherwise in a time frame that is less that the intervals at which the aggregating system obtains the consumption information.

In a further example use case, the systems of the present invention may be configured to operate according to a demand side response (DSR) or peak shaving program. Under a DSR program, the system may be configured to react to indications from grid operators about outages or planned maintenances in certain areas by reducing a load on the power grid.

FIG. 7 shows a flow diagram depicting an example DSR method 700. The method comprises, in step 702, receiving, at the meter or the control unit, an indication of a power outage or planned maintenances from a power grid operator. In step 704, the system may control the output of EV chargers connected to the meter in response to the indication, for example to reduce an output of the EV charger. To assist with the DSR method, the EV chargers may be configured to provide updated consumption and/or output information at regular intervals, for example every 5 minutes or less. The system may also be configured such that the EV chargers respond to the control command in a short period of time, for example in 1 minute or less.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A system for controlling a vehicle-to-everything (V2X) compatible electric vehicle charger, the system comprising:
a multi-port meter comprising:
a grid port configured for connecting the meter to an electric power grid;
an auxiliary port configured for connecting the meter to an electric vehicle charger;
a load port configured for connecting the meter to a premises load;
a grid switch connected to the grid port and configured for connecting the grid port to the load port;
a bi-directional communication channel configured for communications between the system and the electric vehicle charger or an electric vehicle connected to the electric vehicle charger;
and
a control unit, the control unit comprising one or more processors configured for processing power grid data measured by the meter and controlling states of the grid switch;
wherein the system is configured to:
open the grid switch to electrically disconnect the grid port and the load port;
transmit a signal to the electric vehicle charger to turn on its V2X output to an output mode; and
provide the output of the electric vehicle charge to the premises load via the auxiliary port and the load port.

2. The system of claim 1, wherein the system is configured to open the grid switch in response to the system detecting a loss of power from the electric power grid.

3. The system of claim 1, wherein the system is configured to open the grid switch in response to an indication that electricity unit prices from the electric power grid have exceeded a threshold value.

4. The system of claim 1, wherein the system is configured to open the grid switch in response to an indication that usage of the electric power grid has exceeded a threshold proportion of its total capacity.

5. The system of claim 1, wherein the system is configured to:
transmit a second signal to the electric vehicle charger to turn off its V2X output; and
close the grid switch.

6. The system of claim 5, wherein the system is configured to receive a confirmation signal from an electric vehicle charger indicating that the V2X output has been turned off; and
wherein the system is configured to close the grid switch in response to the receipt of the confirmation signal by the system.

7. A system for controlling a vehicle-to-everything (V2X) compatible electric vehicle charger, the system comprising:
a multi-port meter comprising:
a grid port configured for connecting the meter to an electric power grid;
an auxiliary port configured for connecting the meter to the electric vehicle charger;
a load port configured for connecting the meter to a premises load;
a grid switch connected to the grid port and configured for connecting the grid port to the load port;
an auxiliary switch configured for connecting the auxiliary port to the grid switch and the load port;
a bi-directional communication channel configured for communications between the system and the electric vehicle charger or an electric vehicle connected to the electric vehicle charger; and
a control unit, the control unit comprising one or more processors configured for processing power grid data measured by the meter and controlling states of the grid switch and the auxiliary switch;
wherein the system is configured to:
responsive to a first condition, determine that the electric vehicle charger should cease charging a battery of an electric vehicle;
transmit a signal to the electric vehicle charger to cease charging the battery of the electric vehicle;
responsive to a second condition, determine that the electric vehicle charger should resume charging the battery of the electric vehicle; and
transmit a second signal to the electric vehicle charger to resume charging the battery of the electric vehicle.

8. The system of claim 7, wherein the first condition is a price of energy from the electric power grid being above a threshold price, and wherein the second condition is the price of energy from the electric power grid being below a second threshold price.

9. The system of claim 8, wherein the first threshold price and the second threshold price are equal.

10. The system of claim 7, wherein the system is configured to:
responsive to a third condition, determine that the electric vehicle charger should output energy to the electric power grid;
transmit a third signal to the electric vehicle charger to turn on its V2X output to an output mode; and
provide the output of the electric vehicle charger to the electric power grid via the auxiliary port and the grid port.

11. The system of claim 10, wherein the first condition is a price of energy from the electric power grid being above a threshold price, and wherein the second condition is the price of energy from the electric power grid being below a second threshold price, and the third condition is the price of energy from the electric power grid being above a third threshold price.

12. The system of claim 11, wherein the first threshold price and the second threshold price are equal, and wherein the third threshold price is greater than the first threshold price.

13. The system of claim 10, wherein the third condition comprises receiving an indication to output energy to the grid.

14. The system of claim 10, wherein the third condition comprises determining that the current charge level of the battery of the electric vehicle is greater than a threshold charge level.

15. The system of claim 7, comprising receiving, from a user a set of user comfort settings, the user comfort settings comprising one or more charging conditions, and
wherein the first condition comprises the one or more charging conditions.

16. The system of claim 15, wherein the user comfort settings comprise an intended use time for the electric vehicle, and wherein the one or more charging conditions comprises only ceasing charging of the battery of the electric vehicle if it is not within a threshold time period of the intended use time.

17. (canceled)

18. A method of controlling a vehicle-to-everything (V2X) compatible electric vehicle charger, method comprising:
operatively connecting a multi-port meter to an electric power grid via a grid port of a multi-port meter;
operatively connecting the multi-port meter to an electric vehicle charger via an auxiliary port of the multi-port meter;
operatively connecting the multi-port meter to premises load via a load port of the multi-port meter;
opening a grid switch to electrically disconnect the grid port and the load port;
transmitting a signal to the electric vehicle charger to turn on its V2X output to an output mode; and
providing the output of the electric vehicle charge to the premises load via the auxiliary port and the load port.

19. The method of claim 18, wherein the method comprises opening the grid switch in response to detecting a loss of power from the electric power grid.

20. The method of claim 18, wherein the method comprises opening the grid switch in response to an indication that electricity unit prices from the electric power grid have exceeded a threshold value.

21. The method of claim 18, wherein the method comprises opening the grid switch in response to an indication that usage of the electric power grid has exceeded a threshold proportion of its total capacity; and/or transmitting a second signal to the electric vehicle charger to turn off its V2X output; and
closing the grid switch.

22.-25. (canceled)
